(19) United States
(12) Patent Application Publication
(10) Pub. No.: US 2017/0080677 A1
(43) Pub. Date: Mar. 23, 2017

(54) ADHESIVE SHEET

(71) Applicant: NITTO DENKO CORPORATION, Osaka (JP)

(72) Inventors: Hiroshi WADA, Osaka (JP); Yuki TSUBAKI, Osaka (JP); Takahisa KUSUURA, Tokyo (JP); Wataru MATSUMOTO, Yamanashi (JP)

(73) Assignee: NITTO DENKO CORPORATION, Osaka (JP)

(21) Appl. No.: 15/270,667

(22) Filed: Sep. 20, 2016

(30) Foreign Application Priority Data
Sep. 23, 2015 (JP) 2015-186181

(51) Int. Cl. B32B 3/30; B32B 7/12

(52) U.S. Cl. CPC B32B 3/30; B32B 7/12; B32B 2405/00

(57) ABSTRACT

The present invention relates to an adhesive sheet including an adhesive layer, in which the adhesive sheet includes a plurality of columnar fine structures which are disposed upright on at least one surface of the adhesive layer and are capable of forming channels for expelling air bubbles, between the adhesive layer and an adherend.

### FIELD OF THE INVENTION

The present invention relates to an adhesive sheet.

### BACKGROUND OF THE INVENTION

An adhesive sheet is a sheet-shaped object to which an adhesive has been applied beforehand and, hence, has an advantage in that the adhesive sheet is free from the trouble of applying an adhesive each time a sheet-shaped object is applied to an adherend. Such adhesive sheets are used in various applications.

However, general adhesive sheets have had a problem in that since the adhesive sheets each have a flat adhesive layer having an even thickness, there are cases where air bubbles are trapped when applying the adhesive sheet to an adherend, if a sufficient care is not taken in the application, and it is difficult to expel the air bubbles which have been trapped.

Known as an adhesive sheet for preventing such air bubble trapping is, for example, an adhesive sheet in which fine beads have been dispersedly disposed near the surface of the adhesive layer to form, on the surface of the adhesive layer, recesses and protrusions due to the fine beads. This adhesive sheet is intended so that when applying the adhesive sheet to an adherend, channel areas for air bubble expelling (the gap between the adhesive layer and the adherend) which are based on the recesses and protrusions are formed between the adhesive layer and the adherend. In this adhesive sheet, the channel areas formed upon application of the adhesive layer to an adherend gradually disappear due to the flowability of the adhesive layer and it is possible to expel the trapped air bubbles with the disappearance of the channel areas. In addition, the increased area of contact with the adherend brings about high adhesive strength.

### SUMMARY OF THE INVENTION

The adhesive sheet including fine beads described above exhibits the function of effectively expelling air bubbles, so long as the fine beads are present near the surface of the adhesive layer at the time when the adhesive sheet is applied to an adherend. However, there has been a problem in that the fine beads which were dispersedly disposed in the surface of the adhesive layer are gradually buried in the adhesive layer with the lapse of time from the production to just before application and, as a result, when actually applying this adhesive sheet to an adherend, it has become impossible to form channel areas which are based on recesses and protrusions and are capable of sufficiently exhibiting the function of expelling air bubbles.

An object of the present invention, which has been achieved in order to overcome the problem, is to provide an adhesive sheet which can sufficiently exhibit the function of expelling air bubbles, at the time of application to an adherend.

The above-mentioned object is achieved by an adhesive sheet including an adhesive layer, in which the adhesive sheet includes a plurality of columnar fine structures which are disposed upright on at least one surface of the adhesive layer and are capable of forming channels for expelling air bubbles, between the adhesive layer and an adherend.

In this adhesive sheet, it is preferable that the columnar fine structures are nanostructures.

It is preferable that the columnar fine structures have an aspect ratio [(maximum diameter):length] of from 1:5 to 1:50,000.

It is preferable that the columnar fine structures are nanowires.

It is preferable that the plurality of columnar fine structures are disposed on the surface of the adhesive layer in a predetermined pattern arrangement.

It is preferable that the adhesive sheet further includes a release liner disposed on the surface of the adhesive layer, and housing parts for housing the columnar fine structures therein are provided on a surface of the release liner, which faces the adhesive layer.

It is preferable that the columnar fine structures disposed upright on the surface of the adhesive layer have a protruding height of 0.5 μm to 500 μm.

According to the present invention, it is possible to provide an adhesive sheet which can sufficiently exhibit the function of expelling air bubbles, at the time of application to an adherend.

### BRIEF DESCRIPTION OF THE DRAWING

FIG. 1 is a diagrammatic cross-sectional view which illustrates the configuration of an adhesive sheet according to the present invention.

FIG. 2 is an enlarged view of a main part of FIG. 1.

FIG. 3 is an enlarged view of a main part, illustrating a modification of the columnar fine structures shown in FIG. 2.

FIGS. 4A and 4B are plan views which illustrate examples regarding the region where the columnar fine structures shown in FIG. 1 are disposed.

FIGS. 5A and 5B are views for illustrating a definition of the protruding height of columnar fine structures disposed upright on one surface of an adhesive layer.

FIG. 6 is a view for illustrating the function of an adhesive sheet according to the present invention.

FIG. 7 is a view for illustrating the function of the adhesive sheet according to the present invention.

FIG. 8 is a view for illustrating the function of the adhesive sheet according to the present invention.

FIGS. 9A and 9B are enlarged cross-sectional views of important parts, illustrating modifications of the adhesive sheet according to the present invention.

FIG. 10 is an enlarged cross-sectional view of a main part, illustrating another modification of the adhesive sheet according to the present invention.

### DETAILED DESCRIPTION OF THE INVENTION

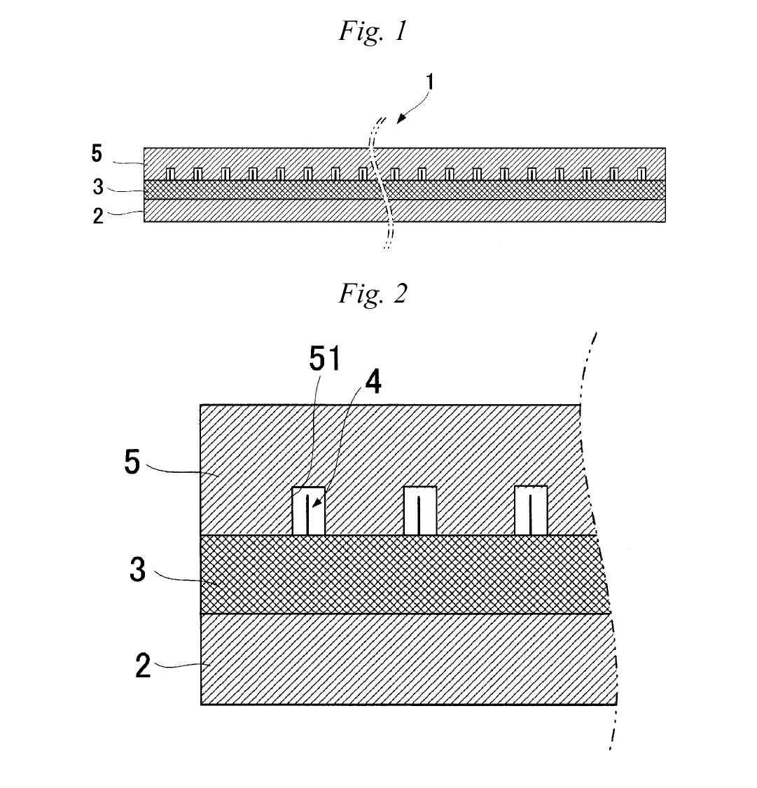

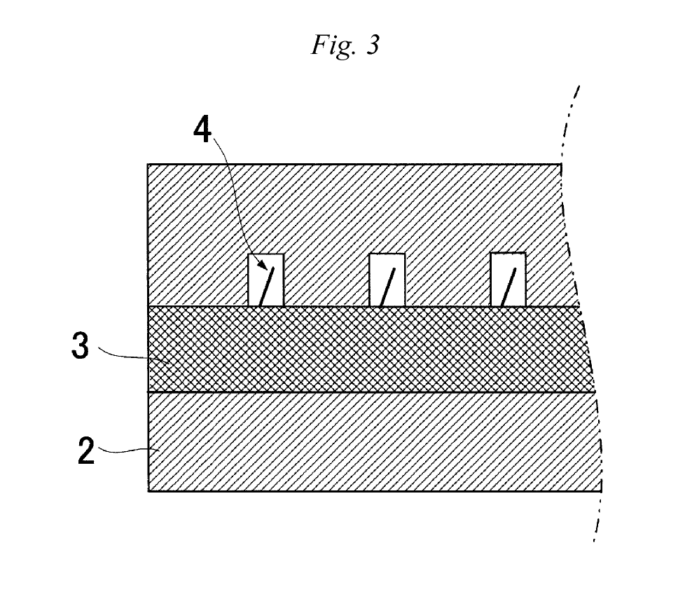

Adhesive sheets according to embodiments of the present invention are explained below by reference to the accompanying drawings. Each drawing has been partly enlarged or reduced for the purpose of easy understanding of the configuration. FIG. 1 is a diagrammatic cross-sectional view which illustrates the configuration of an adhesive sheet according to one embodiment of the present invention, and FIG. 2 is an enlarged view of a main part of FIG. 1. The adhesive sheet 1 according to the present invention is an adhesive sheet to be applied to an adherend. As shown in FIG. 1 and FIG. 2, this adhesive sheet 1 includes a substrate 2, an adhesive layer 3, columnar fine structures 4, and a release liner 5. The adhesive layer 3 is disposed on one surface of the substrate 2, and the release liner 5 is disposed on the surface of the adhesive layer 3, which is an opposite side from the substrate 2.

As the substrate 2, use can be made of one which is generally used as the substrates 2 of adhesive sheets. Examples of the material constituting the substrate 2 include resinous materials (e.g., sheet-shaped or net-shaped materials, woven fabric, nonwoven fabric, and foamed sheets), paper, and metals. The substrate 2 may be constituted of a single layer, or may be composed of multiple layers constituted of the same or different materials. Examples of resins for constituting the substrate 2 include polyesters, polyolefins, ethylene/vinyl acetate copolymers, ethylene/(meth)acrylic acid copolymers, ethylene/(meth)acrylic ester copolymers, ethylene/butene copolymers, ethylene/hexene copolymers, polyurethanes, polyetherketones, poly(vinyl alcohol), poly(vinylidene chloride), poly(vinyl chloride), vinyl chloride/vinyl acetate copolymers, poly(vinyl acetate), polyamides, polyimides, cellulosic resins, fluororesins, silicone resins, polyethers, polystyrene-based resins (e.g., polystyrene), polycarbonates, polyethersulfones, and crosslinked forms of these resins.

The thickness of the substrate 2 can be suitably set. However, the thickness thereof is preferably 0.5 μm to 1,000 μm, and it is more preferred to set the thickness thereof at a value in the range of 5 μm to 500 μm. Any appropriate surface treatment may be given to the substrate 2 in accordance with purposes. Examples of the surface treatment include a treatment with chromic acid, exposure to ozone, exposure to a flame, exposure to high-voltage electric shocks, treatment with ionizing radiation, matting, corona discharge treatment, priming, and crosslinking.

The adhesive layer 3 can be formed from any of various adhesives which are generally used as the adhesive layers of adhesive sheets, such as pressure-sensitive adhesives, thermoplastic adhesives, and thermosetting adhesives. The thickness of the adhesive layer 3 can be suitably set. However, the thickness thereof is preferably 1 μm to 500 μm, and it is more preferred to set the thickness thereof at a value in the range of 5 μm to 300 μm.

The adhesive layer 3 can be a pressure-sensitive adhesive layer formed from either an aqueous pressure-sensitive adhesive composition or a solvent-based pressure-sensitive adhesive composition. The term “aqueous pressure-sensitive adhesive composition” means a pressure-sensitive adhesive composition configured of a medium including water as the main component (aqueous medium) and a pressure-sensitive adhesive (ingredient for pressure-sensitive-adhesive layer formation) contained in the medium. This conception of aqueous pressure-sensitive adhesive composition can include compositions which are called aqueous dispersion type pressure-sensitive adhesive compositions (compositions of the type configured of water and a pressure-sensitive adhesive dispersed therein), aqueous solution type pressure-sensitive adhesive compositions (compositions of the type configured of water and a pressure-sensitive adhesive dissolved therein), and the like. Meanwhile, the term “solvent-based pressure-sensitive adhesive composition” means a pressure-sensitive adhesive composition configured of an organic solvent and a pressure-sensitive adhesive contained therein.

In the techniques disclosed herein, the kind of the pressure-sensitive adhesive included in the adhesive layer 3 is not particularly limited. For example, the pressure-sensitive adhesive can be one which includes, as one or more base polymers, one or more polymers selected from among various polymers capable of functioning as pressure-sensitive adhesive ingredients (polymers having pressure-sensitive adhesiveness), such as acrylic polymers, polyesters, urethane polymers, polyethers, rubbers, silicones, polyamides, and fluoropolymers. In a preferred mode, the main component of the adhesive layer 3 is an acrylic pressure-sensitive adhesive. The techniques disclosed herein can be advantageously practiced in the form of a double-faced pressure-sensitive adhesive sheet having pressure-sensitive adhesive layers each constituted substantially of an acrylic pressure-sensitive adhesive. The pressure-sensitive adhesive layers typically are pressure-sensitive adhesive layers formed from a pressure-sensitive adhesive composition including a polymer having pressure-sensitive adhesiveness (preferably, an acrylic polymer).

The term “acrylic pressure-sensitive adhesive” herein means a pressure-sensitive adhesive which includes an acrylic polymer as a base polymer (a main component of the polymer component(s); i.e., a component accounting for more than 50% by mass of the polymer component(s)). The term “acrylic polymer” means a polymer for which one or more monomers each having at least one (meth)acryloyl group in one molecule thereof (hereinafter, these monomers are often referred to as “acrylic monomers”) were used as a main constituent monomer component (a main component of all the monomers; i.e., a component accounting for more than 50% by mass of all the monomers for constituting the acrylic polymer). In this specification, the term “(meth)acryloyl group” inclusively means an acryloyl group and a methacryloyl group. Likewise, “(meth)acrylate” inclusively means an acrylate and a methacrylate.

The acrylic polymer typically is a polymer produced using one or more alkyl (meth)acrylates as a main constituent monomer component. For example, compounds represented by the following formula (1) are suitably used as the alkyl (meth)acrylates.

CH₂=C(R¹)COOR² (1)

R¹ in formula (1) is a hydrogen atom or a methyl group. R² is an alkyl group having 1-20 carbon atoms. Alkyl (meth)acrylates in which R² is an alkyl group having 2-14 carbon atoms (hereinafter, this range of the number of carbon atoms is often referred to as C₂₋₁₄) are preferred since a pressure-sensitive adhesive having excellent pressure-sensitive adhesive performance is apt to be obtained with such alkyl (meth)acrylates. Examples of the C₂₋₁₄ alkyl group include ethyl, propyl, isopropyl, n-butyl, isobutyl, s-butyl, t-butyl, n-pentyl, isoamyl, neopentyl, n-hexyl, n-heptyl, n-octyl, isooctyl, 2-ethylhexyl, n-nonyl, isononyl, n-decyl, isodecyl, n-undecyl, n-dodecyl, n-tridecyl, and n-tetradecyl.

In a preferred mode, about 50% by mass or more (typically 50-99.9% by mass), more preferably 70% by mass or more (typically 70-99.9% by mass), and, for example, about 85% by mass or more (typically 85-99.9% by mass), of all the monomers to be used for synthesizing the acrylic polymer is accounted for by one or more monomers selected from among alkyl (meth)acrylates represented by formula (1) in which R² is a C₂₋₁₄ alkyl (more preferably C₄₋₁₀-alkyl (meth)acrylates; especially preferably, butyl acrylate and/or 2-ethylhexyl acrylate). Such a monomer composition is preferred because an acrylic polymer obtained therefrom is apt to give a pressure-sensitive adhesive which shows satisfactory pressure-sensitive adhesive properties.

In the techniques disclosed herein, acrylic polymers in which an acrylic monomer having a hydroxyl group (—OH) has been copolymerized can be preferably used. Examples of the acrylic monomer having a hydroxyl group include 2-hydroxyethyl (meth)acrylate, 2-hydroxypropyl (meth)acrylate, 3-hydorxypropyl (meth)acrylate, 2-hydroxybutyl (meth)acrylate, 4-hyroxybutyl (meth)acrylate, 2-hydroxyhexyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylcyclohexyl)methyl acrylate, polypropylene glycol mono(meth)acrylate, N-hydroxyethyl(meth)acrylamide, and N-hydroxypropyl(meth)acrylamide. One of such hydroxyl-containing acrylic monomers may be used alone, or two or more thereof may be used in combination.

Such hydroxyl-containing acrylic monomers are preferred because an acrylic polymer in which such a monomer has been copolymerized is apt to give a pressure-sensitive adhesive which has an excellent balance between pressure-sensitive adhesive force and cohesive force and further has excellent re-releasability. Especially preferred examples of the hydroxyl-containing acrylic monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, and 4-hydroxybutyl (meth)acrylate. For example, a hydroxyalkyl (meth)acrylate in which the alkyl group in the hydroxyalkyl group is a linear group having 2-4 carbon atoms can be preferably used.

It is preferable that such a hydroxyl-containing acrylic monomer is used in an amount in the range of about 0.001-10% by mass based on all the monomers to be used for synthesizing the acrylic polymer. Such use of the hydroxyl-containing acrylic monomer makes it possible to produce a pressure-sensitive adhesive sheet in which the pressure-sensitive adhesive force and the cohesive force are balanced on a higher level. By regulating the use amount of the hydroxyl-containing acrylic monomer to about 0.01-5% by mass (e.g., 0.05-2% by mass), better results can be achieved.

In the acrylic polymer in the techniques disclosed herein, monomers other than those shown above (“other monomers”) may be copolymerized so long as the effects of the present invention are not considerably impaired. Such monomers can be used, for example, for the purposes of regulating the Tg of the acrylic polymer, regulating the pressure-sensitive adhesive performance (e.g., releasability) thereof, etc. Examples of monomers capable of improving the cohesive force and heat resistance of the pressure-sensitive adhesive include monomers containing a sulfonic group, monomers containing a phosphate group, monomers containing a cyano group, vinyl esters, and aromatic vinyl compounds. Meanwhile, examples of monomers capable of introducing a functional group serving as a crosslinking site into the acrylic polymer or of contributing to an improvement in adhesive strength include monomers containing a carboxyl group, monomers containing an acid anhydride group, monomers containing an amide group, monomers containing an amino group, monomers containing an imido group, monomers containing an epoxy group, (meth)acryloylmorpholine, and vinyl ethers.

Examples of the monomers containing a sulfonic group include styrenesulfonic acid, allylsulfonic acid, 2-(meth)acrylamido-2-methylpropanesulfonic acid, (meth)acrylamidopropanesulfonic acid, sulfopropyl (meth)acrylate, (meth)acryloyloxynaphthalenesulfonic acid, and sodium vinylsulfonate. Examples of the monomers containing a phosphate group include 2-hydroxyethyl acryloyl phosphate. Examples of the monomers containing a cyano group include acrylonitrile and methacrylonitrile. Examples of the vinyl esters include vinyl acetate, vinyl propionate, and vinyl laurate. Examples of the aromatic vinyl compounds include styrene, chlorostyrene, chloromethylstyrene, a-methylstyrene, and other substituted styrenes.

Examples of the monomers containing a carboxyl group include acrylic acid, methacrylic acid, carboxyethyl (meth)acrylate, carboxypentyl (meth)acrylate, itaconic acid, maleic acid, fumaric acid, crotonic acid, and isocrotonic acid. Examples of the monomers containing an acid anhydride group include maleic anhydride, itaconic anhydride, and the acid anhydrides of those carboxyl-containing monomers. Examples of the monomers containing an amide group include acrylamide, methacrylamide, diethylacrylamide, N-vinylpyrrolidone, N,N-dimethylacrylamide, N,N-dimethylmethacrylamide, N,N-diethylacrylamide, N,N-diethylmethacrylamide, N,N′-methylenebisacrylamide, N,N-dimethylaminopropylacrylamide, N,N-dimethylaminopropylmethacrylamide, and diacetoneacrylamide. Examples of the monomers containing an amino group include aminoethyl (meth)acrylate, N,N-dimethylaminoethyl (meth)acrylate, and N,N-dimethylaminopropyl (meth)acrylate. Examples of the monomers containing an imide group include cyclohexylmaleimide, isopropylmaleimide, N-cyclohexylmaleimide, and itaconimide. Examples of the monomers containing an epoxy group include glycidyl (meth)acrylate, methylglycidyl (meth)acrylate, and allyl glycidyl ether. Examples of the vinyl ethers include methyl vinyl ether, ethyl vinyl ether, and isobutyl vinyl ether.

One of such “other monomers” may be used alone, or two or more thereof may be used in combination. However, the total content of such other monomers based on all the monomers to be used for synthesizing the acrylic polymer is preferably about 40% by mass or less (typically 0.001-40% by mass), more preferably about 30% by mass or less (typically 0.01-30% by mass, e.g., 0.1-10% by mass). In the case of using a carboxyl-containing monomer as one of the other monomers, the content thereof based on all the monomers can be, for example, 0.1-10% by mass, and an appropriate range thereof is usually 0.5-5% by mass. Meanwhile, in the case of using a vinyl ester (e.g., vinyl acetate) as one of the other monomers, the content thereof based on all the monomers can be, for example, 0.1-20% by mass, and an appropriate range thereof is usually 0.5-10% by mass.

It is desirable that the comonomer composition for the acrylic polymer is designed so that the polymer has a glass transition temperature (Tg) of −15° C. or lower (typically −70° C. to −15° C.). The Tg thereof is preferably −25° C. or lower (e.g., −60° C. to −25° C.), more preferably −40° C. or lower (e.g., −60° C. to −40° C.). In case where the Tg of the acrylic polymer is too high, there can be cases where the pressure-sensitive adhesive containing this acrylic polymer as a base polymer is prone to be reduced in pressure-sensitive adhesive force (e.g., pressure-sensitive adhesive force in low-temperature environments, pressure-sensitive adhesive force in application to rough surfaces, etc.). In case where the Tg of the acrylic polymer is too low, there can be cases where the pressure-sensitive adhesive has reduced adhesiveness to curved surfaces or has reduced re-releasability (which results in, for example, adhesive transfer).

The Tg of the acrylic polymer can be regulated by suitably changing the monomer composition (i.e., the kinds and proportions of the monomers to be used for synthesizing the polymer). The term “Tg of an acrylic polymer” means a value determined using the Fox equation from the Tg of a homopolymer of each of the monomers used for constituting the polymer and from the mass proportions of the monomers (copolymerization ratio by mass). As the Tg of homopolymers, the values shown in a known document are employed

In the techniques disclosed herein, the following values are specifically used as the Tg of homopolymers.

| | | |
|---|---|---|
| 2-Ethylhexyl acrylate | −70° | C. |
| Butyl acrylate | −55° | C. |
| Ethyl acrylate | −22° | C. |
| Methyl acrylate | 8° | C. |
| Methyl methacrylate | 105° | C. |
| Cyclohexyl methacrylate | 66° | C. |
| Vinyl acetate | 32° | C. |
| Styrene | 100° | C. |
| Acrylic acid | 106° | C. |
| Methacrylic acid | 130° | C. |

With respect to the Tg of homopolymers other than those shown above as examples, the values given in “Polymer Handbook” (3rd ed., John Wiley & Sons, Inc., 1989) are used.

In the case of a monomer, the Tg of a homopolymer of which is not given in “Polymer Handbook” (3rd ed., John Wiley & Sons, Inc., 1989), the value obtained by the following measuring method is used (see JP-A-2007-51271). Specifically, 100 parts by mass of the monomer, 0.2 parts by mass of azobisisobutyronitrile, and 200 parts by mass of ethyl acetate as a polymerization solvent are introduced into a reactor equipped with a thermometer, stirrer, nitrogen introduction tube, and reflux condenser, and the contents are stirred for 1 hour while passing nitrogen gas therethrough. The oxygen present in the polymerization system is thus removed, and the contents are then heated to 63° C. to react the monomer for 10 hours. Subsequently, the reaction mixture is cooled to room temperature to obtain a homopolymer solution having a solid concentration of 33% by mass. This homopolymer solution is then applied to a release liner by casting and dried to produce a test sample (sheet-shaped homopolymer) having a thickness of about 2 mm. A disk-shaped specimen having a diameter of 7.9 mm is punched out from the test sample, sandwiched between parallel plates, and examined for viscoelasticity using a viscoelastometer (trade name “ARES”, manufactured by Rheometric Inc.) in the shear mode under the conditions of a temperature range of −70 to 150° C. and a heating rate of 5° C./min while giving thereto a shear strain with a frequency of 1 Hz. The temperature corresponding to the tans (loss tangent) peak top is taken as the Tg of the homopolymer.

It is preferable that the pressure-sensitive adhesive in the techniques disclosed herein is designed so that the peak top temperature regarding the shear loss modulus G″ thereof is −10° C. or lower (typically −10° C. to −40° C.). For example, a preferred pressure-sensitive adhesive is one which is designed so that the peak top temperature is −15° C. to −35° C. In this specification, the peak top temperature regarding shear loss modulus G″ can be understood by punching out a disk-shaped specimen having a diameter of 7.9 mm from a sheet-shaped pressure-sensitive adhesive having a thickness of 1 mm, sandwiching the specimen between parallel plates, examining the specimen for the temperature dependence of loss modulus G″ using the viscoelastometer (trade name “ARES”, manufactured by Rheometric Inc.) in the shear mode under the conditions of a temperature range of −70 to 150° C. and a heating rate of 5° C./min while giving thereto a shear strain with a frequency of 1 Hz, and determining the temperature corresponding to the top of a peak of the temperature dependence (i.e., the temperature at which the G″ curve is maximal). The peak top temperature regarding shear loss modulus G″ of the acrylic polymer can be regulated by suitably changing the monomer composition (i.e., the kinds and proportions of the monomers to be used for synthesizing the polymer).

Methods for obtaining an acrylic polymer having such monomer composition are not particularly limited, and various polymerization methods known as techniques for synthesizing acrylic polymers, such as solution polymerization, emulsion polymerization, bulk polymerization, and suspension polymerization, can be suitably employed. For example, solution polymerization can be preferably used. As a method for feeding monomers when performing solution polymerization, use can be suitably made of an en bloc monomer introduction method, in which all the starting monomers are fed at a time, a continuous-feeding (dropping) method, installment-feeding (dropping) method, or the like. A polymerization temperature can be suitably selected in accordance with the kinds of the monomers and solvent used, the kind of the polymerization initiator, etc. For example, the temperature can be about 20-170° C. (typically 40-140° C.).

The solvent to be used for the solution polymerization can be suitably selected from known or common organic solvents. For example, use can be made of any one of the following solvents or a mixed solvent composed of two or more of the following solvents: aromatic compounds (typically aromatic hydrocarbons) such as toluene and xylene; aliphatic or alicyclic hydrocarbons such as ethyl acetate, hexane, cyclohexane, and methylcyclohexane; halogenated alkanes such as 1,2-dichloroethane; lower alcohols (e.g., monohydric alcohols having 1-4 carbon atoms) such as isopropyl alcohol, 1-butanol, sec-butanol, and tert-butanol; ethers such as tert-butyl methyl ether; ketones such as methyl ethyl ketone and acetylacetone; and the like. It is preferred to use an organic solvent (which can be a mixed solvent) having a boiling point of 20-200° C. (more preferably 25-150° C.) at a total pressure of 1 atm.

The initiator to be used in the polymerization can be suitably selected from known or common polymerization initiators in accordance with the kind of the polymerization method. For example, an azo polymerization initiator can be preferably used. Examples of the azo polymerization initiator include 2,2′-azobisisobutyronitrile, 2,2′-azobis(2-methylpropionamidine) disulfate, 2,2′-azobis(2-amidinopropane) dihydrochloride, 2,2′-azobis[2-(5-methyl-2-imidazolin-2-yl)propane] dihydrochloride, 2,2′-azobis(N,N′-dimethyleneisobutylamidine), 2,2′-azobis[N-2-carboxyethyl]-2-methylpropionamidine] hydrate, 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-1-carbonitrile), 2,2′-azobis(2,4,4-trimethylpentane), and dimethyl 2,2′-azobis(2-methylpropionate).

Other examples of the polymerization initiator include: persulfates such as potassium persulfate and ammonium persulfate; peroxide initiators such as benzoyl peroxide, t-butyl hydroperoxide, di-t-butyl peroxide, t-butyl peroxybenozate, dicumyl peroxide, 1,1-bis(t-butylperoxy)-3,3,5-trimethylcyclohexane, 1,1-bis(t-butylperoxy)cyclododecane, and hydrogen peroxide; substituted-ethane initiators such as phenyl-substituted ethanes; and aromatic carbonyl compounds. Still other examples of the polymerization initiator include redox initiators each based on a combination of a peroxide and a reducing agent. Examples of the redox initiators include a combination of a peroxide and ascorbic acid (e.g., combination of hydrogen peroxide and ascorbic acid), a combination of a peroxide and an iron(II) salt (e.g., combination of hydrogen peroxide and an iron(II) salt), and a combination of a persulfate and sodium hydrogen sulfite.

One of such polymerization initiators can be used alone, or two or more thereof can be used in combination. The polymerization initiator may be used in an ordinary amount. For example, the use amount thereof can be selected from the range of about 0.005-1 part by mass (typically 0.01-1 part by mass) per 100 parts by mass of all the monomer ingredients.

According to this solution polymerization, a liquid polymerization reaction mixture in the form of a solution of an acrylic polymer in the organic solvent is obtained. This liquid polymerization reaction mixture as such or after having undergone an appropriate post-treatment can be preferably used as the acrylic polymer in the techniques disclosed herein. Typically, the acrylic-polymer-containing solution which has undergone a post-treatment is regulated so as to have an appropriate viscosity (concentration) and then used. Alternatively, use may be made of a solution obtained by synthesizing an acrylic polymer by a polymerization method other than solution polymerization (e.g., emulsion polymerization, photopolymerization, or bulk polymerization) and dissolving the polymer in an organic solvent.

When the acrylic polymer in the techniques disclosed herein has too low a weight-average molecular weight (Mw), there can be cases where the pressure-sensitive adhesive is prone to have insufficient cohesive force to cause adhesive transfer to adherend surfaces or is prone to have reduced adhesiveness to curved surfaces. Meanwhile, when the Mw thereof is too high, there can be cases where the pressure-sensitive adhesive is prone to have reduced pressure-sensitive adhesive force in application to adherends. From the standpoint of balancing pressure-sensitive adhesive performance with re-releasability on a high level, an acrylic polymer having an Mw in the range of 10×10⁴ to 500×10⁴ is preferred. An acrylic polymer having an Mw of 20×10⁴ to 100×10⁴ (e.g., 30×10⁴ to 70×10⁴) can bring about better results. In this specification, the values of Mw are ones obtained through GPC (gel permeation chromatography) and calculated for standard polystyrene.

The pressure-sensitive adhesive composition in the techniques disclosed herein can be a composition which contains a tackifier resin. The tackifier resin is not particularly limited, and use can be made of various tackifier resins including, for example, rosin-based resins, terpene-based resins, hydrocarbon-based resins, epoxy resins, polyamide-based resins, elastomer-based resins, phenolic resins, and ketone-based resins. One of such tackifier resins can be used alone, or two or more thereof can be used in combination.

Examples of the rosin-based tackifier resins include: unmodified rosins (crude rosins) such as gum rosin, wood rosin, and tall oil rosin; modified rosins (hydrogenated rosins, disproportionated rosins, polymerized rosins, and other chemically modified rosins) obtained by modifying those unmodified rosins by hydrogenation, disproportionation, polymerization, etc.; and other rosin derivatives. Examples of the rosin derivatives include: rosin esters such as ones (esterified rosins) obtained by esterifying unmodified rosins with an alcohol and ones (esterified modified rosins) obtained by esterifying modified rosins (hydrogenated rosins, disproportionated rosins, polymerized rosins, etc.) with an alcohol; unsaturated-fatty-acid-modified rosins obtained by modifying unmodified rosins or modified rosins (hydrogenated rosins, disproportionated rosins, polymerized rosins, etc.) with an unsaturated fatty acid; unsaturated-fatty-acid-modified rosin esters obtained by modifying rosin esters with an unsaturated fatty acid; rosin alcohols obtained by reducing at least some of the carboxyl groups of unmodified rosins, modified rosins (hydrogenated rosins, disproportionated rosins, polymerized rosins, etc.), unsaturated-fatty-acid-modified rosins, or unsaturated-fatty-acid-modified rosin esters; metal salts of rosins such as unmodified rosins, modified rosins, and various rosin derivatives (in particular, rosin esters); and rosin-phenol resins obtained by causing phenol to add to rosins (unmodified rosins, modified rosins, various rosin derivatives, etc.) with the aid of an acid catalyst and thermally polymerizing the addition products.

Examples of the terpene-based tackifier resins include: terpene-based resins such as a-pinene polymers, β-pinene polymers, and dipentene polymers; and modified terpene-based resins obtained by modifying these terpene-based resins (by modification with phenol, modification with an aromatic, modification by hydrogenation, modification with a hydrocarbon, etc.). Examples of the modified terpene resins include terpene-phenol resins, styrene-modified terpene-based resins, aromatic-modified terpene-based resins, and hydrogenated terpene-based resins.

Examples of the hydrocarbon-based tackifier resins include various hydrocarbon-based resins such as aliphatic-hydrocarbon resins, aromatic-hydrocarbon resins, alicyclic-hydrocarbon resins, aliphatic/aromatic petroleum resins (e.g., styrene/olefin copolymers), aliphatic/alicyclic petroleum resins, hydrogenated hydrocarbon resins, coumarone-based resins, and coumarone-indene resins. Examples of the aliphatic-hydrocarbon resins include polymers of one or more aliphatic hydrocarbons selected from among olefins and dienes which have about 4 or 5 carbon atoms. Examples of the olefins include 1-butene, isobutylene, and 1-pentene. Examples of the dienes include butadiene, 1,3-pentadiene, and isoprene. Examples of the aromatic-hydrocarbon resins include polymers of vinyl-group-containing aromatic hydrocarbons having about 8-10 carbon atoms (e.g., styrene, vinyltoluene, α-methylstyrene, indene, and methylindene). Examples of the alicyclic-hydrocarbon resins include: alicyclic-hydrocarbon-based resins obtained by subjecting a so-called “C4 petroleum fraction” or “C5 petroleum fraction” to cyclizing dimerization and then polymerizing the dimerization product; polymers of cyclodiene compounds (e.g., cyclopentadiene, dicyclopentadiene, ethylidenenorbornene, and dipentene) or products of hydrogenation of these polymers; and alicyclic-hydrocarbon-based resins obtained by hydrogenating the aromatic rings of either aromatic-hydrocarbon resins or aliphatic/aromatic petroleum resins.

In the techniques disclosed herein, a tackifier resin having a softening point (softening temperature) of about 80° C. or higher (preferably about 100° C. or higher) can be preferably used. With this tackifier resin, an adhesive sheet having higher performance (e.g., high adhesiveness) can be rendered possible. There is no particular upper limit on the softening point of the tackifier resin, and the softening point thereof can be about 200° C. or lower (typically about 180° C. or lower). The term “softening point of a tackifier resin” used herein is defined as a value measured through the softening point measuring method (ring-and-ball method) as defined in JIS K5902:1969 or JIS K2207:1996.

The amount of the tackifier resin to be used is not particularly limited, and can be suitably set in accordance with desired pressure-sensitive adhesive performance (adhesive strength, etc.). For example, it is preferred to use the tackifier resin in an amount of about 10-100 parts by mass (more preferably 15-80 parts by mass, even more preferably 20-60 parts by mass) on a solid basis per 100 parts by mass of the acrylic polymer.

A crosslinking agent may be used in the pressure-sensitive adhesive composition according to need. The kind of the crosslinking agent is not particularly limited, and use can be made of a crosslinking agent suitably selected from among known or common crosslinking agents (e.g., isocyanate-based crosslinking agents, epoxy-based crosslinking agents, oxazoline-based crosslinking agents, aziridine-based crosslinking agents, melamine-based crosslinking agents, peroxide-based crosslinking agents, urea-based crosslinking agents, metal-alkoxide-based crosslinking agents, metal-chelate-based crosslinking agents, metal-salt-based crosslinking agents, carbodiimide-based crosslinking agents, and amine-based crosslinking agents). One crosslinking agent can be used alone, or two or more crosslinking agents can be used in combination. The amount of the crosslinking agent to be used is not particularly limited, and the amount thereof can be selected, for example, from the range of up to about 10 parts by mass (for example, about 0.005-10 parts by mass, preferably about 0.01-5 parts by mass) per 100 parts by mass of the acrylic polymer.

The pressure-sensitive adhesive composition can be one which, according to need, contains various additives that are common in the field of pressure-sensitive adhesive compositions, such as leveling agents, crosslinking aids, plasticizers, softeners, fillers, colorants (pigments, dyes, etc.), antistatic agents, antioxidants, ultraviolet absorbers, oxidation inhibitors, and light stabilizers. With respect to such various additives, conventionally known ones can be used in ordinary ways. Since such additives do not especially characterize the present invention, detailed explanations thereon are omitted here.

The columnar fine structures 4 are a member disposed upright on the surface of the adhesive layer 3, which faces the release liner 5, and have the function of forming channel areas (gap; channels for expelling air bubbles) for expelling air bubbles trapped between the adhesive layer 3 and an adherend. As the columnar fine structures 4, use can be made of nanostructures such as nanowires, e.g., metal nanowires, silicon nanowires, and polymer nanowires, carbon nanotubes, nanocoils, or the like. With respect to the size of the columnar fine structures 4, it is preferred to set the maximum diameter thereof at about 1 nm to 100 nm and the length thereof at about 0.5 μm to 500 μm. Especially with respect to length, it is preferred to set the length thereof at about 1.0 μm to 100 μm. With respect to aspect ratio [(maximum diameter):length], columnar fine structures having an aspect ratio of from 1:5 to 1:50,000 are suitable for use. More preferred are columnar fine structures having an aspect ratio [(maximum diameter):length] of from 1:10 to 1:10,000. The columnar fine structures 4 may be configured so as to be upright approximately perpendicularly to the surface of the adhesive layer 3 as shown in FIG. 2, or may be configured so as to be upright inclinedly at a predetermined angle with the surface of the adhesive layer 3 as shown in FIG. 3. Since the columnar fine structures 4 are constituted of nanostructures and the structures themselves are exceedingly lightweight, the columnar fine structures 4 are never buried in the adhesive layer 3 and are kept upright on the surface of the adhesive layer 3, unless the columnar fine structures 4 receive external force other than gravitational force or a shock or the like.

The nanostructures can be formed by a conventionally known method. For example, nanostructures (metal nanowires) can be formed by a method in which a die having an array of fine holes with an opening diameter of 10 nm to 50 μm is pushed against a metallic material and the metal is extruded, while being heated, through the openings of the die, as disclosed in JP-A-2012-52188. The nanostructures formed by such a method are stabbed into one surface of an adhesive layer 3. Thus, the nanostructures (columnar fine structures 4) can be disposed upright on the adhesive layer 3.

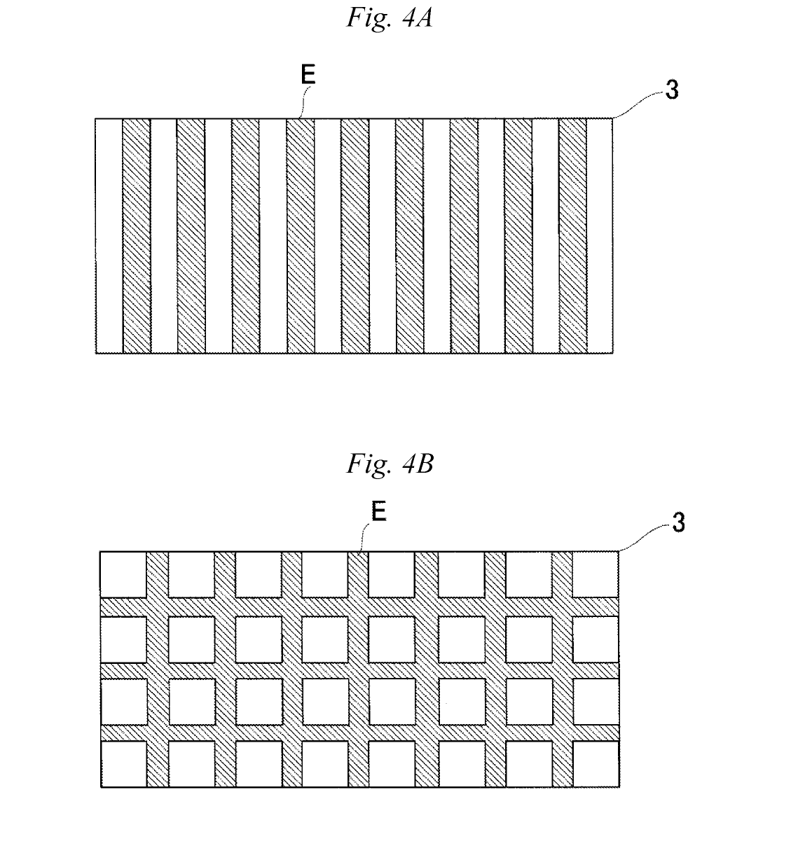

The adhesive sheet 1 may be configured so that columnar fine structures 4 are dispersedly disposed approximately evenly on one surface of the adhesive layer 3. Alternatively, columnar fine structures may be disposed in a region E which constitutes a predetermined pattern shape, e.g., a striped pattern or a lattice pattern as shown in FIGS. 4A and 4B. Furthermore, columnar fine structures 4 may be disposed so as to form a pattern in which, when the adhesive layer 3 is viewed from the plan-view direction, the number density of the upright columnar fine structures 4 gradually increases from the center toward the periphery.

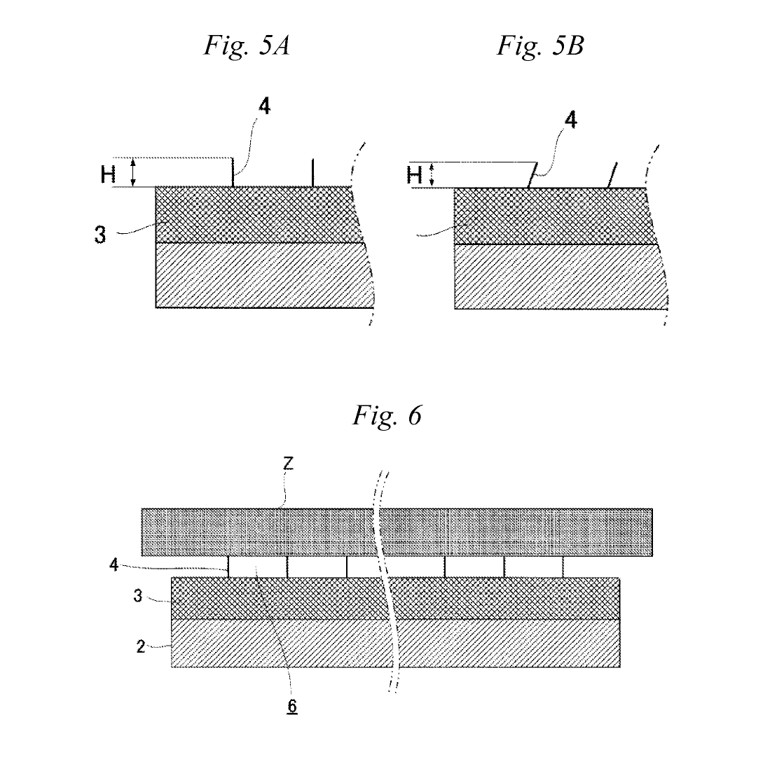

It is preferable that the protruding height of the columnar fine structures 4 disposed upright on one surface of the adhesive layer 3 is set at a value in the numerical range of 0.5 μm to 500 μm, more preferably in the range of 1.0 μm to 100 μm. The term “protruding height of the columnar fine structures 4” means the distance from the surface of the adhesive layer 3 where the columnar fine structures are disposed upright to the ends of the columnar fine structures 4 (distance along the direction perpendicular to the surface of the adhesive layer 3). In FIGS. 5A and 5B, the protruding height is the height dimensions indicated by H.

The number density of the columnar fine structures 4 disposed upright on one surface of the adhesive layer 3 is preferably 1.0×10⁹/cm² or higher, more preferably 5.0×10⁹/cm² or higher, even more preferably 1.0×10¹⁰/cm² or higher. Meanwhile, the number density of the columnar fine structures 4 on the one surface of the adhesive layer 3 is preferably 1.0×10¹⁴/cm² or lower, more preferably 1.0×10¹³/cm² or lower, even more preferably 1.0×10¹²/cm² or lower. In cases when the number density of the columnar fine structures 4 disposed upright on one surface of the adhesive layer 3 is within that range, the function of expelling air bubbles can be effectively exhibited.

The release liner 5 is a member which includes a liner base and a release layer (releasing coating film) and which is disposed on the adhesive layer 3 so that the release layer faces the adhesive layer 3. The release layer can be formed from, for example, a silicone-based release agent. Examples of the silicone-based release agent include thermosetting silicone-based release agents and silicone-based release agents curable with ionizing radiation. Materials usable for forming the release layer are not limited to silicone-based release agents, and a suitable one can be selected in accordance with the kind of the adhesive constituting the adhesive layer 3. Although the thickness of the release liner 5 can be suitably set, it is preferred to set the thickness thereof at a value in the range of 10 μm to 200 μm.

Housing parts 51 for housing the columnar fine structures 4 therein are formed on one surface of the release liner 5, which faces the adhesive layer 3. These housing parts 51 are depressions formed on the surface of the release liner 5. Due to the disposition of the housing parts 51, the columnar fine structures 4 on the adhesive sheet 1 in an unused state can be prevented from receiving external force other than the weight thereof and, hence, the upright state of the columnar fine structures 4 disposed on the surface of the adhesive layer 3 can be maintained without fail. Specific configurations of the housing parts 51 are not limited to recessed shapes such as that shown in FIG. 2. For example, the housing parts 51 may be through-holes which pierce the whole thickness of the release liner 5. In FIG. 2 and FIG. 3, each housing part 51 is configured so that a single columnar fine structure 4 is housed therein. However, configurations of the housing parts 51 are not particularly limited to such configurations, and each housing part 51 may be configured so that a plurality of columnar fine structures 4 are housed therein. Furthermore, in the case where columnar fine structures 4 are disposed within a region having a predetermined pattern shape as shown in FIG. 4A or FIG. 4B, housing parts 51 may be formed so as to have a shape corresponding to the pattern region.

The adhesive sheet 1 having the configuration described above has the following effects. When the release liner 5 is peeled from the adhesive layer 3 and the surface of the adhesive layer 3 which has the columnar fine structures 4 disposed upright thereon is then applied to an adherend, channel areas 6 (gap) for air bubble expelling which are based on the columnar fine structure 4 are formed between the adhesive sheet 1 and the adherend Z as shown in FIG. 6, thereby making it possible to effectively expel, through the channel areas 6 (channels for air bubble expelling), the air bubbles which were trapped when the adhesive sheet was applied.

Since the columnar fine structures 4 which form the channel areas 6 for air bubble expelling are constituted of nanostructures having a size on the order of nanometer and are exceedingly lightweight, the columnar fine structures 4 are never buried in the adhesive layer 3 unless external force other than gravitational force or a shock or the like is given thereto. At the time of use of the adhesive sheet 1, the state in which the columnar fine structures 4 are upright on the surface of the adhesive layer 3 is hence maintained. Consequently, it is possible to reliably prevent the occurrence of performance deteriorations, such as the trouble in which a member for channel area formation is buried in the adhesive layer just before use to make the adhesive sheet unable to sufficiently perform the function of expelling air bubbles, as in the conventional adhesive sheet in which fine beads for forming channel areas for air bubble expelling are dispersedly disposed on the surface of the adhesive layer.

Furthermore, just after application of the adhesive sheet 1 to an adherend Z, the adhesive layer 3 and the adherend Z are in the state of being adherent to each other in a small contact area since the columnar fine structures 4 are disposed upright on the surface of the adhesive layer 3. Because of this, in cases when, for example, the adhesive sheet 1 is applied in a wrong position, the adhesive sheet 1 can be easily stripped off and applied again to the adherend Z.

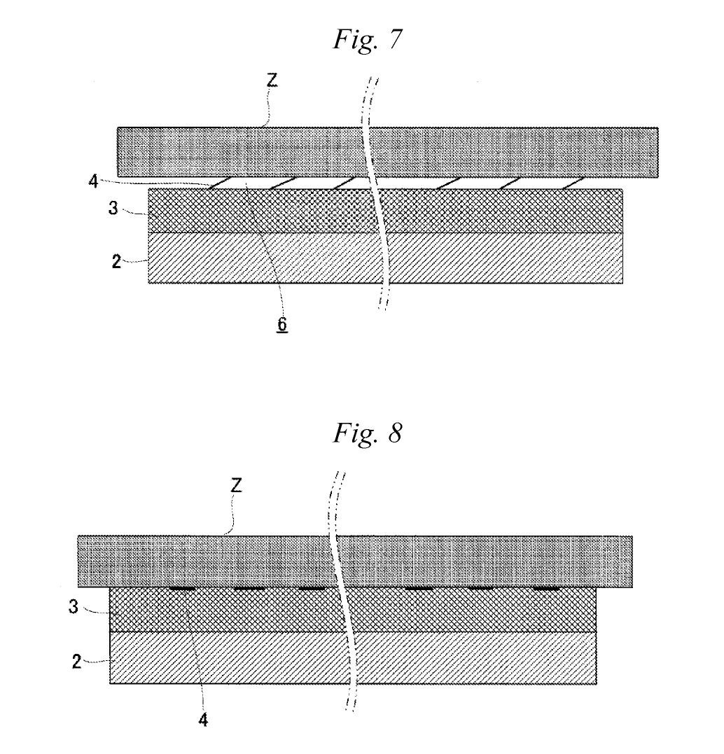

The columnar fine structures 4 disposed upright on the surface of the adhesive layer 3 are slowly inclined toward the adhesive layer 3 by the influence of the viscoelasticity of the adhesive layer 3 itself or are inclined toward the adhesive layer 3 by pushing the adhesive sheet 1, as shown in FIG. 7. Since the columnar fine structures 4, which have a size on the order of nanometer, have a relatively large specific surface area and hence have exceedingly high wettability, the columnar fine structures 4 are finally buried in the adhesive layer 3 as shown in FIG. 8. As a result, the area of contact between the adhesive layer 3 and the adherend Z increases, and the adhesive sheet 1 comes to have improved adhesive performance such as adhesive strength and repulsion resistance.

By configuring the adhesive sheet 1 so that the columnar fine structures 4 disposed upright on one surface of the adhesive layer 3 have a protruding height H of 0.5 μm to 500 μm, channel areas 6 for expelling air bubbles trapped upon application to an adherend Z can be sufficiently ensured. In case where the protruding height H is too large, there is a concern that the columnar fine structures 4 might be not completely inclined toward the adhesive layer 3. By setting the protruding height H to a value within that range, the columnar fine structures 4 can be configured so as to be reliably inclined toward the adhesive layer 3, and the channel areas 6 based on the columnar fine structures 4 can be effectively inhibited from remaining partly.

Although the adhesive sheet 1 according to the present invention has been explained, specific configurations thereof are not limited to the embodiment described above. In the embodiment described above, columnar fine structures 4 formed are stabbed into a surface of an adhesive layer 3 to configure an adhesive sheet 1 in which the columnar fine structures 4 are disposed upright on one surface of the adhesive layer 3. However, methods for disposing columnar fine structures 4 upright are not limited to such a method. For example, a structure including an adhesive layer 3 and columnar fine structures 4 disposed upright on one surface thereof can be obtained also by a method in which columnar fine structures 4 are disposed beforehand in housing parts 51 (depressions) formed in one surface of a release liner 5 and a pressure-sensitive adhesive composition is then applied to that surface of the release liner 5 to thereby form an adhesive layer 3. Meanwhile, in the case where, for example, through-holes are formed as the housing parts 51 of a release liner 5, a structure including an adhesive layer 3 and columnar fine structures 4 disposed upright on one surface thereof can be obtained also by a method in which the release liner 5 is disposed on one surface of an adhesive layer 3 and columnar fine structures 4 are caused to fall onto that surface of the adhesive layer 3 through the through-holes.

In the embodiment described above, the columnar fine structures 4 can be constituted of, for example, nanofiber structures. Examples of the nanofiber structures include cellulose nanofibers and chitin nanofibers. Nanofiber structures are fibers having a diameter of hundreds of nanometers or less, and can be formed by a method such as electrospinning, melt spinning, self-organization, template synthesis, and electroblowing. In the case of using such nanofiber structures to configure columnar fine structures 4, the nanofiber structures cut into a length of, for example, about 0.5 μm to 500 μm are blown against or otherwise applied to one surface of an adhesive layer 3. Thus, nanofiber structures (columnar fine structures 4) disposed upright on the surface of the adhesive layer 3 can be obtained.

In the embodiment describe above, the adhesive sheet 1 from which the release liner 5 has been removed is applied to an adherend Z, and the columnar fine structures 4 are inclined by the influence of the viscoelasticity of the adhesive layer 3 itself or by applying external force to the adhesive sheet 1 by pushing or the like, thereby burying the columnar fine structures 4 in the adhesive layer 3. So long as this configuration is attained, the mode in which columnar fine structures 4 are disposed upright is not particularly limited. For example, columnar fine structures 4 may be disposed upright by using a plurality of columnar fine structures 4 in combination to form three-dimensional structures such as a triangular pyramid shape. Even in the case of columnar fine structures 4 disposed in such mode, the columnar fine structures 4 which have been combined to form triangular pyramid shapes can be inclined and buried in the adhesive layer 3 by applying the adhesive sheet 1 to an adherend and giving external force thereto by, for example, pushing.

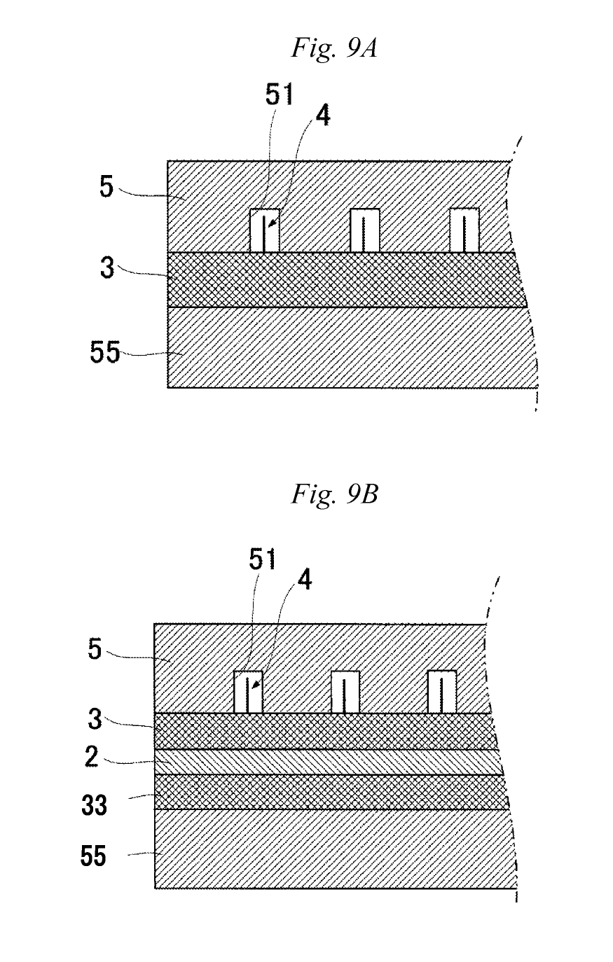

Furthermore, the adhesive sheet 1 according to the embodiment described above is configured as an adhesive sheet of the one-side adhesion type which includes an adhesive layer 3 formed on one surface of the substrate 2 as shown in FIG. 1 and in which an adherend Z is adhered to one-side surface of the adhesive sheet 1 as shown in FIG. 6. However, the substrate 2 in the adhesive sheet 1 is not an essential constituent element of the present invention, and the adhesive sheet 1 may be configured so as to include no substrate 2. Namely, the adhesive sheet 1 may be configured as the both-side adhesion type in which adherends are adhered respectively to both surfaces of the adhesive layer 3 so that the adhesive layer 3 is interposed therebetween. In the case of forming the adhesive sheet 1 as an adhesive sheet of such both-side adhesion type, this adhesive sheet is configured, for example, so that a release liner 5 is disposed on one surface of an adhesive layer 3 and a second release layer 55 is disposed on the other surface thereof as shown in FIG. 9A. Specific structures in the case of configuring the adhesive sheet 1 as an adhesive sheet of the both-side adhesion type are not particularly limited to the substrate-less type described above. For example, an adhesive sheet may be configured by forming an adhesive layer 3 on one surface of a substrate 2, forming a second adhesive layer 33 on the other surface thereof, and superposing release liners 5 and 55 on the exposed surfaces of the adhesive layers 3 and 33, as shown in FIG. 9B.

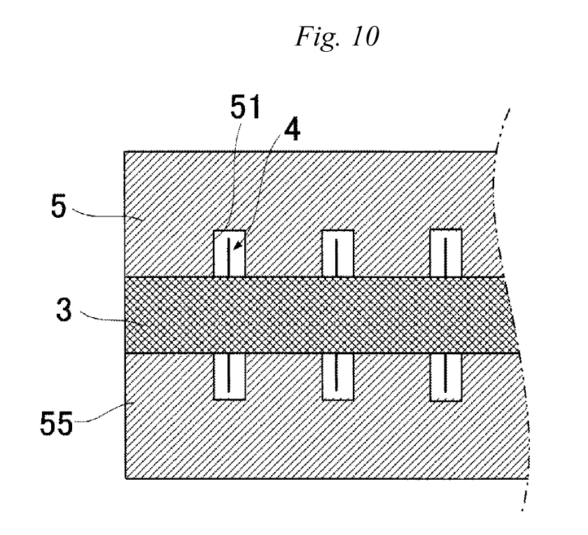

Although the embodiment described above has a structure in which a plurality of columnar fine structures 4 capable of forming channels for expelling air bubbles are disposed upright on one surface of an adhesive layer 3, the adhesive sheet of the present invention is not limited to ones having such a structure. For example, the adhesive sheet 1 can be configured as an adhesive sheet of the both-side adhesion type in which a plurality of columnar fine structures 4 capable of forming channels for expelling air bubbles are disposed upright on each of both surfaces of an adhesive layer 3, as shown in FIG. 10.

The present application is based on Japanese Patent Application No. 2015-186181 filed on Sep. 23, 2015, the contents of which are incorporated herein by reference.

### DESCRIPTION OF REFERENCE NUMERALS AND SIGNS

1 Adhesive sheet

2 Substrate

3 Adhesive layer

4 Columnar fine structure

5 Release liner

51 Housing part

6 Channel area (gap)

Z Adherend

What is claimed is:

1. An adhesive sheet comprising an adhesive layer,
wherein the adhesive sheet comprises a plurality of columnar fine structures which are disposed upright on at least one surface of the adhesive layer and are capable of forming channels for expelling air bubbles, between the adhesive layer and an adherend.

2. The adhesive sheet according to claim 1, wherein the columnar fine structures are nanostructures.

3. The adhesive sheet according to claim 1, wherein the columnar fine structures have an aspect ratio [(maximum diameter):length] of from 1:5 to 1:50,000.

4. The adhesive sheet according to claim 1, wherein the columnar fine structures are nanowires.

5. The adhesive sheet according to claim 1, wherein the plurality of columnar fine structures are disposed on said surface of the adhesive layer in a predetermined pattern arrangement.

6. The adhesive sheet according to claim 1, wherein the adhesive sheet further comprises a release liner disposed on said surface of the adhesive layer, and
housing parts for housing the columnar fine structures therein are provided on a surface of the release liner, which faces the adhesive layer.

7. The adhesive sheet according to claim 1, wherein the columnar fine structures disposed upright on said surface of the adhesive layer have a protruding height of 0.5 μm to 500 μm.
